(19) United States
(12) Patent Application Publication
(10) Pub. No.: US 2021/0126907 A1
(43) Pub. Date: Apr. 29, 2021

(54) Content Protection in Electronic Messaging Systems

(71) Applicant: Citrix Systems, Inc., Fort Lauderdale, FL (US)

(72) Inventors: Bo Zang, Nanjing City (CN); Hao Wu, Nanjing City (CN); Dan Tong, Nanjing City (CN)

(21) Appl. No.: 16/708,873

(22) Filed: Dec. 10, 2019

Related U.S. Application Data
(63) Continuation of application No. PCT/CN2019/113002, filed on Oct. 24, 2019.

(51) Int. Cl. H04L 29/06; H04L 12/58; G06Q 20/14; G06Q 30/02

(52) U.S. Cl. CPC H04L 63/0428; G06Q 30/0241; G06Q 20/14; H04L 51/18

(57) ABSTRACT

Methods, apparatus, and computer-readable media for providing a content protection service in electronic messaging systems are described herein. The content protection service may be engaged by an electronic messaging sending device by receiving a protection action. Or it may be engaged by an electronic messaging server by checking a protection policy. The content protection service may be engaged to alias, and/or conceal an original content item. When aliasing, a modified electronic message content comprises aliased content and omits the original content. When concealing, a modified electronic message content comprises a concealment and omits the original content. When aliasing and concealing, a modified electronic message content comprises a concealment and omits both the aliased and original contents.

### CROSS REFERENCE TO RELATED CASES

This application is a bypass continuation of PCT/CN2019/113002, filed Oct. 24, 2019, and having the same title.

### FIELD

Aspects described herein generally relate to computer hardware and software. More specifically, one or more aspects described herein provides methods, apparatus, and computer-readable media that protect electronic message content within electronic messaging systems.

### BACKGROUND

Electronic messaging (e.g., phone, text, email, electronic messaging applications, etc.) has become an indispensable part of people's work and personal life. People exchange a lot of information via electronic messaging and some people may not be as risk-aware as needed. It is important to provide protection for users' information in electronic messaging systems.

### SUMMARY

The following presents a simplified summary of various aspects described herein. This summary is not an extensive overview, and is not intended to identify required or critical elements or to delineate the scope of the claims. The following summary merely presents some concepts in a simplified form as an introductory prelude to the more detailed description provided below.

Aspects described herein provide methods, apparatus, and computer-readable media for an electronic messaging system content protection service. The content protected may be any sensitive content, confidential information, private data, or other content desired not to be shared, e.g., names, phone numbers, home or business addresses, social security numbers, identification numbers such as passport, driver's license, or state identification card numbers, social media handles (e.g., Facebook, Instagram, twitter, Tumblr, Weibo, WeChat, etc. account addresses), health information (i.e., HIPPA data), employer numbers, tax information, insurance information, banking information, account information associated with online shopping (e.g., Amazon, eBay, Macy's, etc.), etc.

The electronic messaging system content protection service may automatically alias and/or conceal the protected content. For example, a sender may want to allow a recipient to access specific content only during an event such as a training course which the recipient is registered for, but after the event, they may want the content concealed. Another example is a sender such as a business owner may want their content revealed only to a recipient who is interested in their product. They may want their content concealed until the recipient clicks a button where the content was, as a sign of showing interest, or after providing information about the recipient to the business owner. In another example, a sender might not want their content known to people other than a recipient they send an electronic message content to. If the electronic message content is forwarded to other recipients not among a list of allowed recipients, they might want to have their content concealed. In yet another example, a sender may want to use aliased content instead of their original content. This way, the sender's original content is protected and not revealed to anyone.

According to a first aspect described herein, a content protection service, when engaged, first checks if a content item needs aliasing. If the content item needs aliasing, the protection service further checks if the content item is already aliased. This may be achieved by checking against a content relationship database. Each time a content item is aliased, a new entry of a pair of original content item and aliased content item may be stored in the content relationship database. To decide if the content item is already aliased, the electronic messaging system may inquire the database to see if there is a matching alias. If the content item is not already aliased, an electronic messaging sending device or server may generate an aliased content item by generating a random series of alphanumeric characters according to the same format of the series of alphanumeric characters of the original content item. After the aliased content is generated, or if the content item is already aliased, or if the content item does not need aliasing, the protection service continues to check if the content item needs concealing. If the content item needs concealing, the electronic messaging sending device or server may generate a concealment. The concealment may be in the style of a URL link, a clickable button, an electronic form, etc. After the concealment is generated, or if the content item does not need concealing, the electronic messaging sending device or server may return a modified electronic message content to be relayed onto a next hop or an electronic messaging receiving device to be displayed. Depending on the protection action or the protection policy, the modified electronic message content may be aliased content with the original content omitted, or a concealment with the original content omitted, or a concealment with both the aliased and original contents omitted. The same engagement process may be carried out on more than one content item.

A content protection service may be engaged by an electronic messaging sending device based on a protection action. After a sender composes an electronic message content in an electronic messaging sending application, they may manually select a content item and click a content protection service plug-in to define one or more protection actions. The plug-in may be a button embedded in a part of a user interface of the electronic messaging sending application. Or the electronic messaging sending application may automatically identify a content item by comparing a format of a series of alphanumeric characters to a known format and suggest to the sender a list of protection actions, from which the sender may select one or more protection actions. The electronic messaging system may also suggest one recommended protection action based on the type of the content item or based on machine learning associated with the content protection history of the user account. After a protection action is received, the electronic messaging sending device may engage the content protection service to achieve the desired protection action. The electronic messaging sending device may then modify the electronic message content and send a modified electronic message content via an electronic messaging server to a next hop or an electronic messaging receiving device to be displayed.

A content protection service may be engaged by an electronic messaging server based on a protection policy. After the electronic messaging server receives an electronic message content, the electronic messaging server may check if a protection policy exists. A protection policy may be associated with a sender address or a domain name. The checking content protection policy may be implemented by using a lookup table or list in a content protection policy verification unit on the electronic messaging server. If no protection policy exists, the electronic messaging server may send the electronic message content as is to a next hop. If there exists a protection policy, the electronic messaging server may scan the electronic message content for a content item, and check if the content item matches the protection policy. If the protection policy is to conceal a content item and no scanned content item exists, it matches the concealing policy and the electronic messaging server may send the electronic message content as is to a next hop. If the protection policy is to alias a content item, the electronic messaging server may check the scanned content item against a content relationship database. To decide if the content item is already aliased, the electronic messaging system may inquire the database to see if there is a matching alias. If the content item is already aliased, the electronic messaging server may send the electronic message content as is to a next hop. In other scenarios where the scanned content item does not match a protection policy, the electronic messaging server may engage the content protection service to match the desired protection policy. The electronic messaging server may then modify the electronic message content and send a modified electronic message content to a next hop or an electronic messaging receiving device to be displayed.

According to an illustrative aspect, the electronic messaging system may include an email system, and the electronic message content may include a phone number or an email address.

These and additional aspects may be appreciated with the benefit of the disclosures discussed in further detail below.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIG. 1 depicts an illustrative computer system architecture that may be used in accordance with one or more illustrative aspects described herein.

FIG. 2 depicts an illustrative remote-access system architecture that may be used in accordance with one or more illustrative aspects described herein.

FIG. 3 depicts an illustrative virtualized system architecture that may be used in accordance with one or more illustrative aspects described herein.

FIG. 4 depicts an illustrative cloud-based system architecture that may be used in accordance with one or more illustrative aspects described herein.

FIG. 5 depicts an illustrative content protection electronic messaging system that may be used in accordance with one or more illustrative aspects described herein.

FIG. 6A depicts a flowchart for a content protection service on an electronic messaging sending device in accordance with one or more illustrative aspects described herein.

FIG. 6B depicts a flowchart for engaging a content protection service by an electronic messaging sending device in accordance with one or more illustrative aspects described herein.

FIG. 7A depicts a flowchart for a content protection service on an electronic messaging server in accordance with one or more illustrative aspects described herein.

FIG. 7B depicts a flowchart for engaging a content protection service by an electronic messaging server in accordance with one or more illustrative aspects described herein.

FIG. 8 depicts an illustrative implementation of a content protection service plug-in an electronic messaging sending application in accordance with one or more illustrative aspects described herein.

FIG. 9 depicts an illustrative implementation of a protected content in an electronic messaging receiving application in accordance with one or more illustrative aspects described herein.

FIG. 10 depicts an example method for protecting a content item in an electronic messaging system in accordance with one or more illustrative aspects described herein.

FIG. 11 depicts another example method for protecting a content item in an electronic messaging system in accordance with one or more illustrative aspects described herein.

### DETAILED DESCRIPTION

Currently, information included in an electronic message, such as a phone number, is always available to a recipient. However, a user might not always want to share their phone number, yet want recipients to have a way to contact them via phone. A user might also use a default electronic message signature, and forget that a sensitive content item is included in the signature, not meaning to provide it to the recipients. Unfortunately, electronic messaging systems as presently implemented do not have a viable solution to preventing unwanted content sharing.

As a general introduction to the subject matter described in more details below, aspects described herein are directed towards providing a content protection service in an electronic messaging system. The content protection service may be engaged by an electronic messaging sending device or an electronic messaging server. The content protection service, when engaged, aliases and/or conceals sensitive contents. After a recipient receives a protected content, additional steps are required to reveal the protected content. This way, sensitive content is not exposed to a recipient unconditionally. A computer, a remote-access, a virtualized, and a cloud-based system architecture that may be used to host an electronic messaging system are depicted.

Computing Architecture

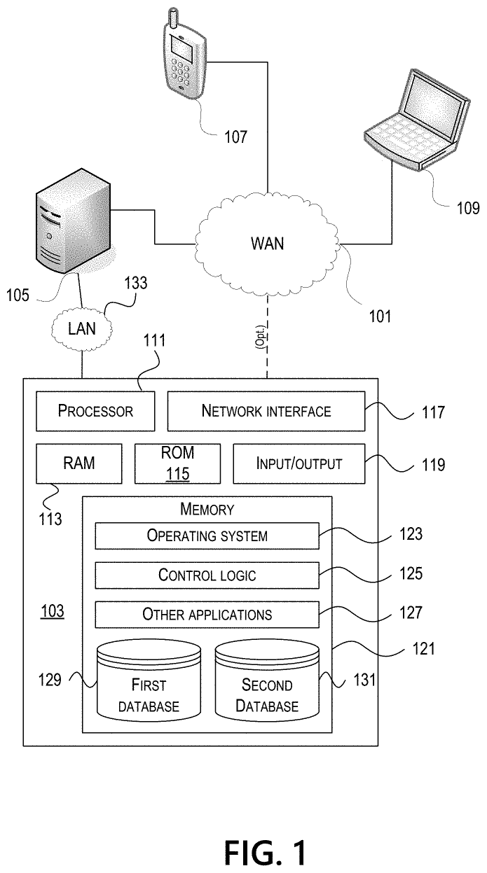

Computer software, hardware, and networks may be utilized in a variety of different system environments, including standalone, networked, remote-access (also known as remote desktop), virtualized, and/or cloud-based environments, among others. FIG. 1 illustrates one example of a system architecture and data processing device that may be used to implement one or more illustrative aspects described herein in a standalone and/or networked environment. Various network nodes 103, 105, 107, and 109 may be interconnected via a wide area network (WAN) 101, such as the Internet. Other networks may also or alternatively be used, including private intranets, corporate networks, local area networks (LAN), metropolitan area networks (MAN), wireless networks, personal networks (PAN), and the like. Network 101 is for illustration purposes and may be replaced with fewer or additional computer networks. A local area network 133 may have one or more of any known LAN topology and may use one or more of a variety of different protocols, such as Ethernet. Devices 103, 105, 107, and 109 and other devices (not shown) may be connected to one or more of the networks via twisted pair wires, coaxial cable, fiber optics, radio waves, or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components may include data server 103, web server 105, and client computers 107, 109. Data server 103 provides overall access, control and administration of databases and control software for performing one or more illustrative aspects describe herein. Data server 103 may be connected to web server 105 through which users interact with and obtain data as requested. Alternatively, data server 103 may act as a web server itself and be directly connected to the Internet. Data server 103 may be connected to web server 105 through the local area network 133, the wide area network 101 (e.g., the Internet), via direct or indirect connection, or via some other network. Users may interact with the data server 103 using remote computers 107, 109, e.g., using a web browser to connect to the data server 103 via one or more externally exposed web sites hosted by web server 105. Client computers 107, 109 may be used in concert with data server 103 to access data stored therein, or may be used for other purposes. For example, from client device 107 a user may access web server 105 using an Internet browser, as is known in the art, or by executing a software application that communicates with web server 105 and/or data server 103 over a computer network (such as the Internet).

Servers and applications may be combined on the same physical machines, and retain separate virtual or logical addresses, or may reside on separate physical machines. FIG. 1 illustrates just one example of a network architecture that may be used, and those of skill in the art may appreciate that the specific network architecture and data processing devices used may vary, and are secondary to the functionality that they provide, as further described herein. For example, services provided by web server 105 and data server 103 may be combined on a single server.

Each component 103, 105, 107, 109 may be any type of known computer, server, or data processing device. Data server 103, e.g., may include a processor 111 controlling overall operation of the data server 103. Data server 103 may further include random access memory (RAM) 113, read only memory (ROM) 115, network interface 117, input/output interfaces 119 (e.g., keyboard, mouse, display, printer, etc.), and memory 121. Input/output (I/O) 119 may include a variety of interface units and drives for reading, writing, displaying, and/or printing data or files. Memory 121 may further store operating system software 123 for controlling overall operation of the data processing device 103, control logic 125 for instructing data server 103 to perform aspects described herein, and other application software 127 providing secondary, support, and/or other functionality which may or might not be used in conjunction with aspects described herein. The control logic 125 may also be referred to herein as the data server software 125. Functionality of the data server software 125 may refer to operations or decisions made automatically based on rules coded into the control logic 125, made manually by a user providing input into the system, and/or a combination of automatic processing based on user input (e.g., queries, data updates, etc.).

Memory 121 may also store data used in performance of one or more aspects described herein, including a first database 129 and a second database 131. In some embodiments, the first database 129 may include the second database 131 (e.g., as a separate table, report, etc.). That is, the information can be stored in a single database, or separated into different logical, virtual, or physical databases, depending on system design. Devices 105, 107, and 109 may have similar or different architecture as described with respect to device 103. Those of skill in the art may appreciate that the functionality of data processing device 103 (or device 105, 107, or 109) as described herein may be spread across multiple data processing devices, for example, to distribute processing load across multiple computers, to segregate transactions based on geographic location, user access level, quality of service (QoS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HyperText Markup Language (HTML) or Extensible Markup Language (XML). The computer executable instructions may be stored on a computer readable medium such as a nonvolatile storage device. Any suitable computer readable storage media may be utilized, including hard disks, CD-ROMs, optical storage devices, magnetic storage devices, solid state storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). Various aspects described herein may be embodied as a method, a data processing system, or a computer program product. Therefore, various functionalities may be embodied in whole or in part in software, firmware, and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

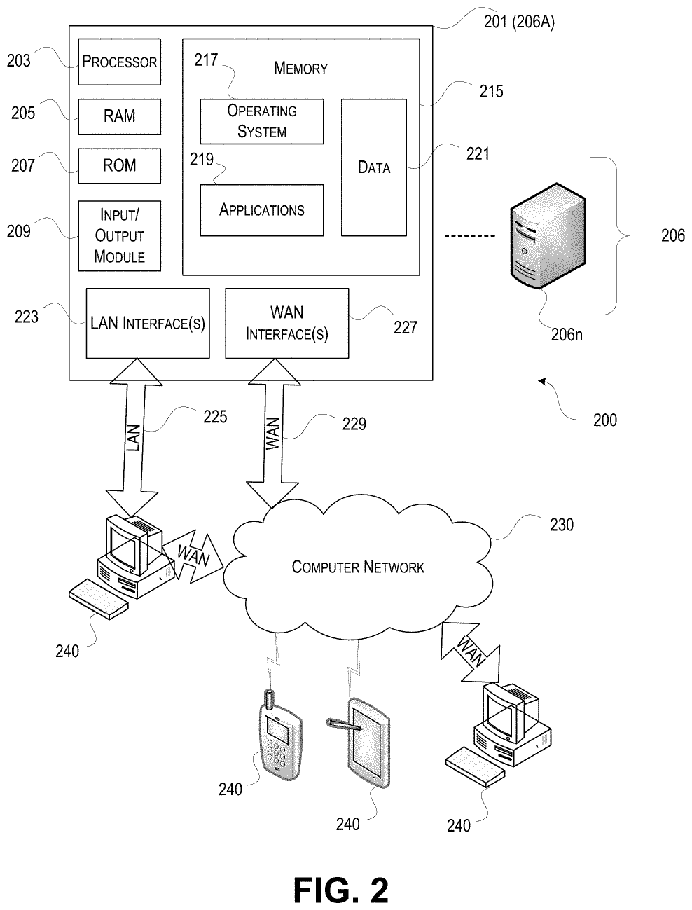

With further reference to FIG. 2, one or more aspects described herein may be implemented in a remote-access environment. FIG. 2 depicts an example system architecture including a computing device 201 in an illustrative computing environment 200 that may be used according to one or more illustrative aspects described herein. Computing device 201 may be used as a server 206a in a single-server or multi-server desktop virtualization system (e.g., a remote access or cloud system) and can be configured to provide virtual machines for client access devices. The computing device 201 may have a processor 203 for controlling overall operation of the device 201 and its associated components, including RAM 205, ROM 207, Input/Output (I/O) module 209, and memory 215.

I/O module 209 may include a mouse, keypad, touch screen, scanner, optical reader, and/or stylus (or other input device(s)) through which a user of computing device 201 may provide input, and may also include one or more of a speaker for providing audio output and one or more of a video display device for providing textual, audiovisual, and/or graphical output. Software may be stored within memory 215 and/or other storage to provide instructions to processor 203 for configuring computing device 201 into a special purpose computing device in order to perform various functions as described herein. For example, memory 215 may store software used by the computing device 201, such as an operating system 217, application programs 219, and an associated database 221.

Computing device 201 may operate in a networked environment supporting connections to one or more remote computers, such as terminals 240 (also referred to as client devices and/or client machines). The terminals 240 may be personal computers, mobile devices, laptop computers, tablets, or servers that include many or all of the elements described above with respect to the computing device 103 or 201. The network connections depicted in FIG. 2 include a local area network (LAN) 225 and a wide area network (WAN) 229, but may also include other networks. When used in a LAN networking environment, computing device 201 may be connected to the LAN 225 through a network interface or adapter 223. When used in a WAN networking environment, computing device 201 may include a modem or other wide area network interface 227 for establishing communications over the WAN 229, such as computer network 230 (e.g., the Internet). It may be appreciated that the network connections shown are illustrative and other means of establishing a communications link between the computers may be used. Computing device 201 and/or terminals 240 may also be mobile terminals (e.g., mobile phones, smartphones, personal digital assistants (PDAs), notebooks, etc.) including various other components, such as a battery, speaker, and antennas (not shown).

Aspects described herein may also be operational with numerous other general purpose or special purpose computing system environments or configurations. Examples of other computing systems, environments, and/or configurations that may be suitable for use with aspects described herein include, but are not limited to, personal computers, server computers, hand-held or laptop devices, multiprocessor systems, microprocessor-based systems, set top boxes, programmable consumer electronics, network personal computers (PCs), minicomputers, mainframe computers, distributed computing environments that include any of the above systems or devices, and the like.

As shown in FIG. 2, one or more client devices 240 may be in communication with one or more servers 206a-206n (generally referred to herein as “server(s) 206”). In one embodiment, the computing environment 200 may include a network appliance installed between the server(s) 206 and client machine(s) 240. The network appliance may manage client/server connections, and in some cases can load balance client connections amongst a plurality of backend servers 206.

The client machine(s) 240 may in some embodiments be referred to as a single client machine 240 or a single group of client machines 240, while server(s) 206 may be referred to as a single server 206 or a single group of servers 206. In one embodiment a single client machine 240 communicates with more than one server 206, while in another embodiment a single server 206 communicates with more than one client machine 240. In yet another embodiment, a single client machine 240 communicates with a single server 206.

A client machine 240 can, in some embodiments, be referenced by any one of the following non-exhaustive terms: client machine(s); client(s); client computer(s); client device(s); client computing device(s); local machine; remote machine; client node(s); endpoint(s); or endpoint node(s). The server 206, in some embodiments, may be referenced by any one of the following non-exhaustive terms: server(s), local machine; remote machine; server farm(s), or host computing device(s).

In one embodiment, the client machine 240 may be a virtual machine. The virtual machine may be any virtual machine, while in some embodiments the virtual machine may be any virtual machine managed by a Type 1 or Type 2 hypervisor, for example, a hypervisor developed by Citrix Systems, IBM, VMware, or any other hypervisor. In some aspects, the virtual machine may be managed by a hypervisor, while in other aspects the virtual machine may be managed by a hypervisor executing on a server 206 or a hypervisor executing on a client 240.

Some embodiments include a client device 240 that displays application output generated by an application remotely executing on a server 206 or other remotely located machine. In these embodiments, the client device 240 may execute a virtual machine receiver program or application to display the output in an application window, a browser, or other output window. In one example, the application is a desktop, while in other examples the application is an application that generates or presents a desktop. A desktop may include a graphical shell providing a user interface for an instance of an operating system in which local and/or remote applications can be integrated. Applications, as used herein, are programs that execute after an instance of an operating system (and, optionally, also the desktop) has been loaded.

The server 206, in some embodiments, uses a remote presentation protocol or other program to send data to a thin-client or remote-display application executing on the client to present display output generated by an application executing on the server 206. The thin-client or remote-display protocol can be any one of the following non-exhaustive list of protocols: the Independent Computing Architecture (ICA) protocol developed by Citrix Systems, Inc. of Ft. Lauderdale, Fla.; or the Remote Desktop Protocol (RDP) manufactured by the Microsoft Corporation of Redmond, Wash.

A remote computing environment may include more than one server 206a-206n such that the servers 206a-206n are logically grouped together into a server farm 206, for example, in a cloud computing environment. The server farm 206 may include servers 206 that are geographically dispersed while logically grouped together, or servers 206 that are located proximate to each other while logically grouped together. Geographically dispersed servers 206a-206n within a server farm 206 can, in some embodiments, communicate using a WAN (wide), MAN (metropolitan), or LAN (local), where different geographic regions can be characterized as: different continents; different regions of a continent; different countries; different states; different cities; different campuses; different rooms; or any combination of the preceding geographical locations. In some embodiments the server farm 206 may be administered as a single entity, while in other embodiments the server farm 206 can include multiple server farms.

In some embodiments, a server farm may include servers 206 that execute a substantially similar type of operating system platform (e.g., WINDOWS, UNIX, LINUX, iOS, ANDROID, etc.) In other embodiments, server farm 206 may include a first group of one or more servers that execute a first type of operating system platform, and a second group of one or more servers that execute a second type of operating system platform.

Server 206 may be configured as any type of server, as needed, e.g., a file server, an application server, a web server, a proxy server, an appliance, a network appliance, a gateway, an application gateway, a gateway server, a virtualization server, a deployment server, a Secure Sockets Layer (SSL) VPN server, a firewall, a web server, an application server or as a master application server, a server executing an active directory, or a server executing an application acceleration program that provides firewall functionality, application functionality, or load balancing functionality. Other server types may also be used.

Some embodiments include a first server 206a that receives requests from a client machine 240, forwards the request to a second server 206b (not shown), and responds to the request generated by the client machine 240 with a response from the second server 206b (not shown.) First server 206a may acquire an enumeration of applications available to the client machine 240 as well as address information associated with an application server 206 hosting an application identified within the enumeration of applications. First server 206a can then present a response to the client's request using a web interface, and communicate directly with the client 240 to provide the client 240 with access to an identified application. One or more clients 240 and/or one or more servers 206 may transmit data over network 230, e.g., network 101.

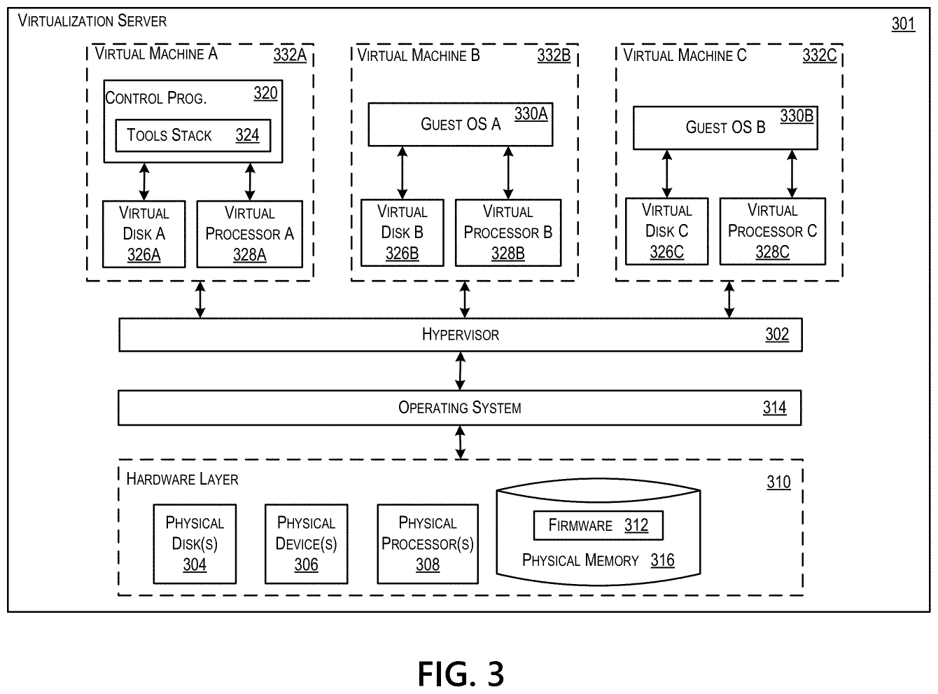

FIG. 3 shows a high-level architecture of an illustrative desktop virtualization system. As shown, the desktop virtualization system may be single-server or multi-server system, or cloud system, including at least one virtualization server 301 configured to provide virtual desktops and/or virtual applications to one or more client access devices 240. As used herein, a desktop refers to a graphical environment or space in which one or more applications may be hosted and/or executed. A desktop may include a graphical shell providing a user interface for an instance of an operating system in which local and/or remote applications can be integrated. Applications may include programs that execute after an instance of an operating system (and, optionally, also the desktop) has been loaded. Each instance of the operating system may be physical (e.g., one operating system per device) or virtual (e g, many instances of an OS running on a single device). Each application may be executed on a local device, or executed on a remotely located device (e.g., remoted).

A computer device 301 may be configured as a virtualization server in a virtualization environment, for example, a single-server, multi-server, or cloud computing environment. Virtualization server 301 illustrated in FIG. 3 can be deployed as and/or implemented by one or more embodiments of the server 206 illustrated in FIG. 2 or by other known computing devices. Included in virtualization server 301 is a hardware layer that can include one or more physical disks 304, one or more physical devices 306, one or more physical processors 308, and one or more physical memories 316. In some embodiments, firmware 312 can be stored within a memory element in the physical memory 316 and can be executed by one or more of the physical processors 308. Virtualization server 301 may further include an operating system 314 that may be stored in a memory element in the physical memory 316 and executed by one or more of the physical processors 308. Still further, a hypervisor 302 may be stored in a memory element in the physical memory 316 and can be executed by one or more of the physical processors 308.

Executing on one or more of the physical processors 308 may be one or more virtual machines 332A-C (generally 332). Each virtual machine 332 may have a virtual disk 326A-C and a virtual processor 328A-C. In some embodiments, a first virtual machine 332A may execute, using a virtual processor 328A, a control program 320 that includes a tools stack 324. Control program 320 may be referred to as a control virtual machine, Dom0, Domain 0, or other virtual machine used for system administration and/or control. In some embodiments, one or more virtual machines 332B-C can execute, using a virtual processor 328B-C, a guest operating system 330A-B.

Virtualization server 301 may include a hardware layer 310 with one or more pieces of hardware that communicate with the virtualization server 301. In some embodiments, the hardware layer 310 can include one or more physical disks 304, one or more physical devices 306, one or more physical processors 308, and one or more physical memory 316. Physical components 304, 306, 308, and 316 may include, for example, any of the components described above. Physical devices 306 may include, for example, a network interface card, a video card, a keyboard, a mouse, an input device, a monitor, a display device, speakers, an optical drive, a storage device, a universal serial bus connection, a printer, a scanner, a network element (e.g., router, firewall, network address translator, load balancer, virtual private network (VPN) gateway, Dynamic Host Configuration Protocol (DHCP) router, etc.), or any device connected to or communicating with virtualization server 301. Physical memory 316 in the hardware layer 310 may include any type of memory. Physical memory 316 may store data, and in some embodiments may store one or more programs, or set of executable instructions. FIG. 3 illustrates an embodiment where firmware 312 is stored within the physical memory 316 of virtualization server 301. Programs or executable instructions stored in the physical memory 316 can be executed by the one or more processors 308 of virtualization server 301.

Virtualization server 301 may also include a hypervisor 302. In some embodiments, hypervisor 302 may be a program executed by processors 308 on virtualization server 301 to create and manage any number of virtual machines 332. Hypervisor 302 may be referred to as a virtual machine monitor, or platform virtualization software. In some embodiments, hypervisor 302 can be any combination of executable instructions and hardware that monitors virtual machines executing on a computing machine. Hypervisor 302 may be Type 2 hypervisor, where the hypervisor executes within an operating system 314 executing on the virtualization server 301. Virtual machines may then execute at a level above the hypervisor 302. In some embodiments, the Type 2 hypervisor may execute within the context of a user's operating system such that the Type 2 hypervisor interacts with the user's operating system. In other embodiments, one or more virtualization servers 301 in a virtualization environment may instead include a Type 1 hypervisor (not shown). A Type 1 hypervisor may execute on the virtualization server 301 by directly accessing the hardware and resources within the hardware layer 310. That is, while a Type 2 hypervisor 302 accesses system resources through a host operating system 314, as shown, a Type 1 hypervisor may directly access all system resources without the host operating system 314. A Type 1 hypervisor may execute directly on one or more physical processors 308 of virtualization server 301, and may include program data stored in the physical memory 316.

Hypervisor 302, in some embodiments, can provide virtual resources to operating systems 330 or control programs 320 executing on virtual machines 332 in any manner that simulates the operating systems 330 or control programs 320 having direct access to system resources. System resources can include, but are not limited to, physical devices 306, physical disks 304, physical processors 308, physical memory 316, and any other component included in hardware layer 310 of the virtualization server 301. Hypervisor 302 may be used to emulate virtual hardware, partition physical hardware, virtualize physical hardware, and/or execute virtual machines that provide access to computing environments. In still other embodiments, hypervisor 302 may control processor scheduling and memory partitioning for a virtual machine 332 executing on virtualization server 301. Hypervisor 302 may include those manufactured by VMWare, Inc., of Palo Alto, Calif.; HyperV, VirtualServer or virtual PC hypervisors provided by Microsoft, or others. In some embodiments, virtualization server 301 may execute a hypervisor 302 that creates a virtual machine platform on which guest operating systems may execute. In these embodiments, the virtualization server 301 may be referred to as a host server. An example of such a virtualization server is the Citrix Hypervisor provided by Citrix Systems, Inc., of Fort Lauderdale, Fla.

Hypervisor 302 may create one or more virtual machines 332B-C (generally 332) in which guest operating systems 330 execute. In some embodiments, hypervisor 302 may load a virtual machine image to create a virtual machine 332. In other embodiments, the hypervisor 302 may execute a guest operating system 330 within virtual machine 332. In still other embodiments, virtual machine 332 may execute guest operating system 330.

In addition to creating virtual machines 332, hypervisor 302 may control the execution of at least one virtual machine 332. In other embodiments, hypervisor 302 may present at least one virtual machine 332 with an abstraction of at least one hardware resource provided by the virtualization server 301 (e.g., any hardware resource available within the hardware layer 310). In other embodiments, hypervisor 302 may control the manner in which virtual machines 332 access physical processors 308 available in virtualization server 301. Controlling access to physical processors 308 may include determining whether a virtual machine 332 should have access to a processor 308, and how physical processor capabilities are presented to the virtual machine 332.

As shown in FIG. 3, virtualization server 301 may host or execute one or more virtual machines 332. A virtual machine 332 is a set of executable instructions that, when executed by a processor 308, may imitate the operation of a physical computer such that the virtual machine 332 can execute programs and processes much like a physical computing device. While FIG. 3 illustrates an embodiment where a virtualization server 301 hosts three virtual machines 332, in other embodiments virtualization server 301 can host any number of virtual machines 332. Hypervisor 302, in some embodiments, may provide each virtual machine 332 with a unique virtual view of the physical hardware, memory, processor, and other system resources available to that virtual machine 332. In some embodiments, the unique virtual view can be based on one or more of virtual machine permissions, application of a policy engine to one or more virtual machine identifiers, a user accessing a virtual machine, the applications executing on a virtual machine, networks accessed by a virtual machine, or any other desired criteria. For instance, hypervisor 302 may create one or more unsecure virtual machines 332 and one or more secure virtual machines 332. Unsecure virtual machines 332 may be prevented from accessing resources, hardware, memory locations, and programs that secure virtual machines 332 may be permitted to access. In other embodiments, hypervisor 302 may provide each virtual machine 332 with a substantially similar virtual view of the physical hardware, memory, processor, and other system resources available to the virtual machines 332.

Each virtual machine 332 may include a virtual disk 326A-C (generally 326) and a virtual processor 328A-C (generally 328.) The virtual disk 326, in some embodiments, is a virtualized view of one or more physical disks 304 of the virtualization server 301, or a portion of one or more physical disks 304 of the virtualization server 301. The virtualized view of the physical disks 304 can be generated, provided, and managed by the hypervisor 302. In some embodiments, hypervisor 302 provides each virtual machine 332 with a unique view of the physical disks 304. Thus, in these embodiments, the particular virtual disk 326 included in each virtual machine 332 can be unique when compared with the other virtual disks 326.

A virtual processor 328 can be a virtualized view of one or more physical processors 308 of the virtualization server 301. In some embodiments, the virtualized view of the physical processors 308 can be generated, provided, and managed by hypervisor 302. In some embodiments, virtual processor 328 has substantially all of the same characteristics of at least one physical processor 308. In other embodiments, virtual processor 308 provides a modified view of physical processors 308 such that at least some of the characteristics of the virtual processor 328 are different than the characteristics of the corresponding physical processor 308.

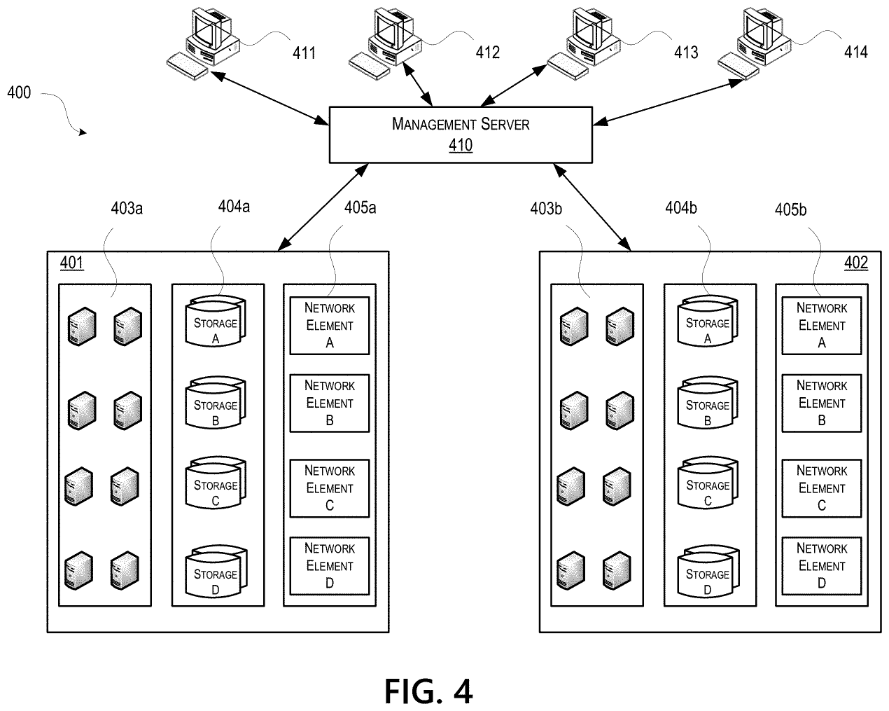

With further reference to FIG. 4, some aspects described herein may be implemented in a cloud-based environment. FIG. 4 illustrates an example of a cloud computing environment (or cloud system) 400. As seen in FIG. 4, client computers 411-414 may communicate with a cloud management server 410 to access the computing resources (e.g., host servers 403a-403b (generally referred herein as “host servers 403”), storage resources 404a-404b (generally referred herein as “storage resources 404”), and network elements 405a-405b (generally referred herein as “network resources 405”)) of the cloud system.

Management server 410 may be implemented on one or more physical servers. The management server 410 may run, for example, Citrix Cloud by Citrix Systems, Inc. of Ft. Lauderdale, Fla., or OPENSTACK, among others. Management server 410 may manage various computing resources, including cloud hardware and software resources, for example, host computers 403, data storage devices 404, and networking devices 405. The cloud hardware and software resources may include private and/or public components. For example, a cloud may be configured as a private cloud to be used by one or more particular customers or client computers 411-414 and/or over a private network. In other embodiments, public clouds or hybrid public-private clouds may be used by other customers over an open or hybrid networks.

Management server 410 may be configured to provide user interfaces through which cloud operators and cloud customers may interact with the cloud system 400. For example, the management server 410 may provide a set of application programming interfaces (APIs) and/or one or more cloud operator console applications (e.g., web-based or standalone applications) with user interfaces to allow cloud operators to manage the cloud resources, configure the virtualization layer, manage customer accounts, and perform other cloud administration tasks. The management server 410 also may include a set of APIs and/or one or more customer console applications with user interfaces configured to receive cloud computing requests from end users via client computers 411-414, for example, requests to create, modify, or destroy virtual machines within the cloud. Client computers 411-414 may connect to management server 410 via the Internet or some other communication network, and may request access to one or more of the computing resources managed by management server 410. In response to client requests, the management server 410 may include a resource manager configured to select and provision physical resources in the hardware layer of the cloud system based on the client requests. For example, the management server 410 and additional components of the cloud system may be configured to provision, create, and manage virtual machines and their operating environments (e.g., hypervisors, storage resources, services offered by the network elements, etc.) for customers at client computers 411-414, over a network (e.g., the Internet), providing customers with computational resources, data storage services, networking capabilities, and computer platform and application support. Cloud systems also may be configured to provide various specific services, including security systems, development environments, user interfaces, and the like.

Certain clients 411-414 may be related, for example, to different client computers creating virtual machines on behalf of the same end user, or different users affiliated with the same company or organization. In other examples, certain clients 411-414 may be unrelated, such as users affiliated with different companies or organizations. For unrelated clients, information on the virtual machines or storage of any one user may be hidden from other users.

Referring now to the physical hardware layer of a cloud computing environment, availability zones 401-402 (or zones) may refer to a collocated set of physical computing resources. Zones may be geographically separated from other zones in the overall cloud of computing resources. For example, zone 401 may be a first cloud datacenter located in California, and zone 402 may be a second cloud datacenter located in Florida. Management server 410 may be located at one of the availability zones, or at a separate location. Each zone may include an internal network that interfaces with devices that are outside of the zone, such as the management server 410, through a gateway. End users of the cloud (e.g., clients 411-414) might or might not be aware of the distinctions between zones. For example, an end user may request the creation of a virtual machine having a specified amount of memory, processing power, and network capabilities. The management server 410 may respond to the user's request and may allocate the resources to create the virtual machine without the user knowing whether the virtual machine was created using resources from zone 401 or zone 402. In other examples, the cloud system may allow end users to request that virtual machines (or other cloud resources) are allocated in a specific zone or on specific resources 403-405 within a zone.

In this example, each zone 401-402 may include an arrangement of various physical hardware components (or computing resources) 403-405, for example, physical hosting resources (or processing resources), physical network resources, physical storage resources, switches, and additional hardware resources that may be used to provide cloud computing services to customers. The physical hosting resources in a cloud zone 401-402 may include one or more computer servers 403, such as the virtualization servers 301 described above, which may be configured to create and host virtual machine instances. The physical network resources in a cloud zone 401 or 402 may include one or more network elements 405 (e.g., network service providers) comprising hardware and/or software configured to provide a network service to cloud customers, such as firewalls, network address translators, load balancers, virtual private network (VPN) gateways, Dynamic Host Configuration Protocol (DHCP) routers, and the like. The storage resources in the cloud zone 401-402 may include storage disks (e.g., solid state drives (SSDs), magnetic hard disks, etc.) and other storage devices.

The example cloud computing environment shown in FIG. 4 also may include a virtualization layer (e.g., as shown in FIGS. 1-3) with additional hardware and/or software resources configured to create and manage virtual machines and provide other services to customers using the physical resources in the cloud. The virtualization layer may include hypervisors, as described above in FIG. 3, along with other components to provide network virtualizations, storage virtualizations, etc. The virtualization layer may be as a separate layer from the physical resource layer, or may share some or all of the same hardware and/or software resources with the physical resource layer. For example, the virtualization layer may include a hypervisor installed in each of the virtualization servers 403 with the physical computing resources. Known cloud systems may alternatively be used, e.g., WINDOWS AZURE (Microsoft Corporation of Redmond Wash.), AMAZON EC2 (Amazon.com Inc. of Seattle, Wash.), IBM BLUE CLOUD (IBM Corporation of Armonk, N.Y.), or others.

Content Protection Service

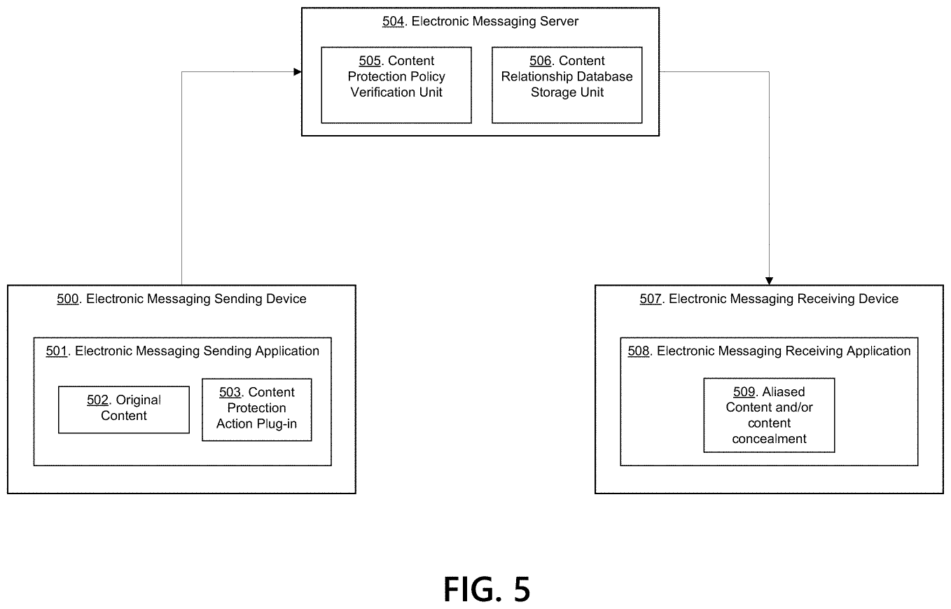

FIG. 5 depicts an illustrative content protection electronic messaging system that may be used in accordance with one or more illustrative aspects described herein. Not only may electronic message content be protected in an electronic messaging system (e.g., via a content protection action plug-in 503 in an electronic messaging sending application 501 on an electronic messaging sending device 500, or via a content protection policy verification unit 505 on an electronic messaging server 504), non-content items such as sender address, CC address, subject content, attachments (e.g., photos, videos, documents, web links, etc.), etc. may also be protected. The system may generally include an electronic messaging sending device 500, an electronic messaging server 504, and an electronic messaging receiving device 507.

The electronic messaging sending device 500 may be a portable personal device such as a phone, a laptop, a desktop computer, etc., that may host a plurality of messaging applications, send text messages, make outgoing phone calls, send emails, etc. In the case of messaging applications, it may be Facebook or Instagram messaging, Messenger, WhatsApp, Snapchat, WeChat, dating applications with messaging functions, etc. In the case of an email sending application, it may be a Citrix Systems, Inc. product such as SecureMail, ShareFile, etc., or it may be other email applications such as eM Client, Thunderbird, Mailbird, Microsoft Outlook, etc. It may also be a webmail product. A user may use the electronic messaging sending application 501 to compose, edit, and send an electronic message content that may contain original content 502.

The electronic message content normally contains at least a body, and optionally a title, and/or one or more attachments (e.g., photos, videos, documents, web links, etc.). The electronic message content may contain original content 502 such as names, phone numbers, home or business addresses, social security numbers, identification numbers such as passport, driver's license, or state identification card numbers, social media handles (e.g., Facebook, Instagram, twitter, Tumblr, Weibo, WeChat, etc. account addresses), health information (i.e., HIPPA data), employer numbers, tax information, insurance information, banking information, account information associated with online shopping (e.g., Amazon, eBay, Macy's, etc.), etc.

After composing an electronic message content in an electronic messaging sending application 501, a user may manually select an original content 502 item, and click a content protection action plug-in 503 to alias and/or conceal the original content 502 item. In one embodiment, the content protection service plug-in 503 may be a button embedded in a user interface of the electronic messaging sending application 501. Engaging a content protection action plug-in 503 in this embodiment may be by clicking on the plug-in. There may be a list of content protection actions, aliasing and/or concealing, for different durations of time or requiring different conditions. If the user does not manually select an original content 502 item and engage the content protection action plug-in 503, the electronic messaging sending application 501 may still automatically detect an original content 502 item, such as a phone number, or an address, etc., and suggest a list of content protection actions by opening a pop-up window of content protection action plug-in 503 to the user, before the user sends the electronic message content. A sender may select one or more protection actions from the suggested list. Automatically detecting an original content item may be achieved by comparing a format of an alphanumerical series to a known format.

The electronic messaging server 504 may be any server (e.g., data server 103, server 206, or management server 410) that may follow protocols of storing and relaying electronic messages, phone calls, text messages, emails, etc. In the case of an email server, it may be an SMTP server, a POP3 server, an MTA server, an IMAP server, etc. The electronic messaging server 504 may receive an electronic message content from the electronic messaging sending device 500. The electronic message content may or may not be protected. There may be a content protection policy associated with a sender address or a domain name, etc. If a content protection policy is required, the electronic messaging server 504 may first check if the electronic message content is already protected by checking against a content relationship database stored in a content relationship database storage unit 506. If the electronic message content is not yet protected, the electronic messaging server 504 may engage a content protection service in a content protection policy verification unit 505 to alias and/or conceal the original electronic message content 502 item.

The electronic messaging receiving device 507 may be a portable personal device such as a phone, a laptop, a desktop computer, etc., that may host a plurality of messaging applications, receive text messages, receive incoming phone calls, receive emails, etc. In the case of messaging applications, it may be Facebook or Instagram messaging, Messenger, WhatsApp, Snapchat, WeChat, dating applications with messaging functions, etc. In the case of an email receiving application, it may be a Citrix Systems, Inc. product such as SecureMail, ShareFile, etc., or it may be other email applications such as eM Client, Thunderbird, Mailbird, Microsoft Outlook, etc. It may also be a webmail product. A user may use the electronic messaging receiving device 507 to receive a modified electronic message content that may contain aliased content and/or content concealment 509.

After an electronic messaging receiving application 508 receives a modified electronic message content from the electronic messaging server 504, it may have already been modified in different ways. The modified content may be aliased content 509. If the content is a phone number, when a recipient calls the aliased phone number, the call may be forwarded to the original phone number when the aliasing stays in effect. The modified content may be concealed content 509. The concealment may be in different forms. In one embodiment, the concealment is a URL link. It may be required to follow the URL link to reveal the concealed content. In another embodiment, the concealment is a clickable button. It may be required to click the button to reveal the concealed content. In yet another embodiment, the concealment is an electronic form. It may be required to fill out some information in the electronic form to reveal the concealed content. In yet another embodiment, the concealment is an advertisement video. It may be required to watch a certain period of time of the advertisement video to reveal the concealed content. The modified content may also contain both aliased content and concealed content 509.

The content protection may be effective permanently or only for a period of time. It may be scheduled to enter being effective only after a period of time. It may be effective only before, during, or after an event. It may be effective only for a particular sender, or a particular recipient.

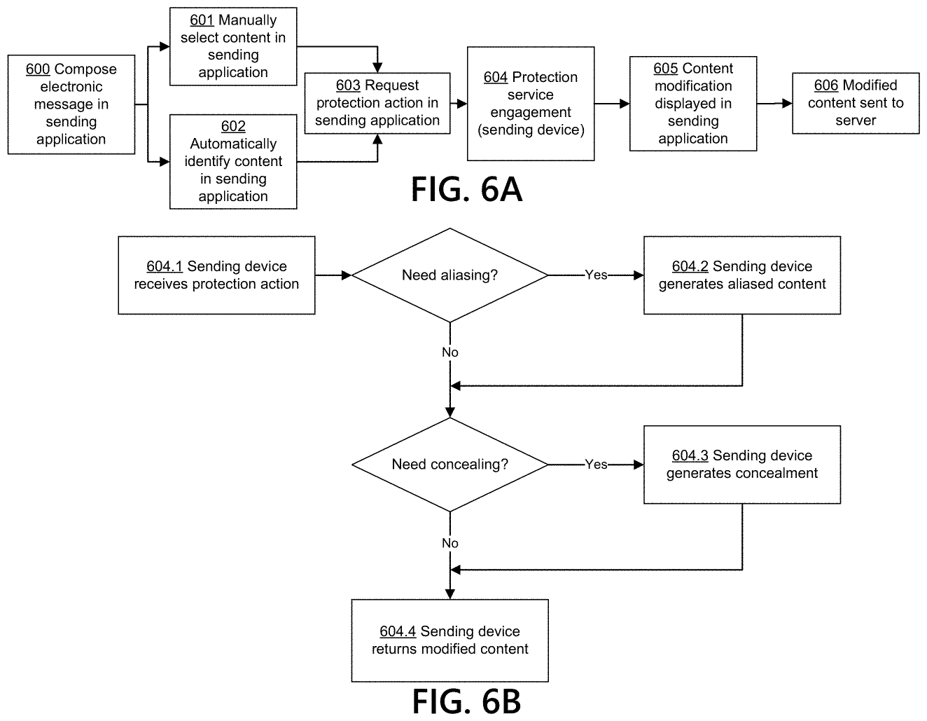

FIG. 6A depicts a flowchart for a content protection service on an electronic messaging sending device (e.g., device 500) in accordance with one or more illustrative aspects described herein. At step 600, a sender may compose an electronic message content in an electronic messaging sending application 501. At step 601, the sender may manually select an original content item in the electronic messaging sending application 501, and at step 603, the sender may manually define a protection action by clicking a content protection action plug-in 503. In one embodiment, the content protection action plug-in 503 may be a button embedded in a part of a user interface of the electronic messaging sending application 501. The sender may define a protection action by clicking on the plug-in and choose a protection action in the pop-up window showing a list of protection actions. Alternatively, at step 602, an electronic messaging sending application 501 may automatically identify an original content 502 item by comparing a format of a series of alphanumeric characters to a known format. For instance, a social security number may have 9 digits, a credit card number may have 16 digits, and a United States passport number may have one letter and 7 digits. The electronic messaging sending application 501 may then suggest a list of protection actions in a pop-up window of a content protection action plug-in 503, from which at step 603, the sender may select a protection action.

A protection action may be to alias, or conceal, or alias and conceal the original content. A protection action may be defined to last permanently or only for a period of time. It may also be defined to take effect only after a period of time. It may be defined to take effect only during a predefined event or only for a predefined sender or a predefined recipient.

Once a protection action is received or requested, at step 604, a content protection service may be engaged by the electronic messaging sending device (e.g., device 500). The electronic messaging sending device 500 may determine whether the protection action comprises aliasing only, concealing only, or both aliasing and concealing a content item. Based on the requested protection action, the electronic messaging sending device 500 may return a corresponding modified content. At step 605, the electronic messaging sending application 501 may display the modified electronic message content. And at step 606, the electronic messaging sending device 500 may send the modified electronic message content to an electronic messaging server (e.g., server 504) to forward it to another electronic messaging device (e.g., electronic messaging receiving device 507).

FIG. 6B depicts a flowchart for engaging a content protection service via a content protection action plug-in 503 in an electronic messaging sending device 500 in accordance with one or more illustrative aspects described herein. At step 604.1, the electronic messaging sending device 500 receives a protection action via a content protection action plug-in 503 in an electronic messaging sending application 501. The electronic messaging sending device 500 first checks the protection action whether aliasing is needed. If aliasing is needed, at step 604.2, the electronic messaging sending device 500 may generate aliased content by generating a random series of alphanumeric characters according to the same format of the series of alphanumeric characters of the original content item. For instance, an aliased United States phone number may have 10 digits including an area code, since the original phone number may have 10 digits. Therefore, a recipient may not be able to tell an aliased phone number apart from an original phone number because they both follow the same format. It may additionally be set up through a telecommunications provider that calling the aliased phone number may be forwarded to the original phone number. What may be transparent to a recipient of the aliased phone number is that the recipient may reach the sender of the phone number, but the original phone number is not exposed.

If aliasing is not needed, or after the electronic messaging sending device 500 generates aliased content, it may further check if the content needs to be concealed. For instance, a Dean of Admissions for a law school may want to collect necessary information (e.g., LSAT scores) from all participants registered for a law school recruiting event. The Dean may send an email to all participants with his email address concealed. To reveal his email address, recipients may be required to enter the necessary information (e.g., LSAT scores). However, the Dean may only want the participants to see an aliased email address that may be valid during this year's recruitment. He may not want his original email address to be leaked to the internet to avoid future prospective applicants emailing him directly without restriction. If the content needs to be concealed, at step 604.3, the electronic messaging sending device 500 may generate a concealment, e.g., a URL link, a clickable button, an electronic form, etc. Then at step 604.4, the electronic messaging sending device 500 may return a modified electronic message content. If the content does not need to be concealed, the electronic messaging sending device 500 may directly go to step 604.4 and return a modified electronic message content. Depending on the protection action, a modified electronic message content may be aliased content with the original content omitted, a concealment with the original number omitted, or a concealment with both the aliased and original contents omitted.

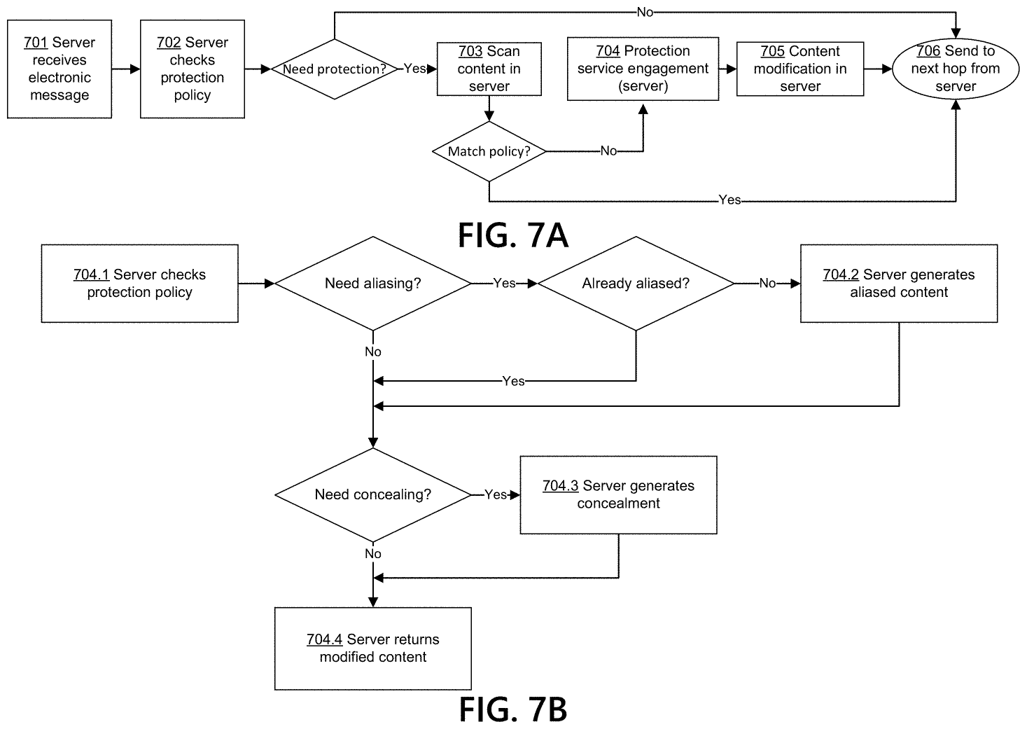

FIG. 7A depicts a flowchart for a content protection service on an electronic messaging server (e.g., server 504) in accordance with one or more illustrative aspects described herein. At step 701, an electronic messaging server 504 receives an electronic message content. At step 702, the electronic messaging server 504 may check if a content protection policy exists. The content protection policy may be associated with a sender address. Or it may be associated with a domain name. The checking content protection policy may be implemented in a content protection policy verification unit 505 by using a lookup table or list. Alternatively, or in addition, security policy file(s) may indicate what types of content protection are permissible, users permitted to use the content protection service, and other limitations that may be placed on users and/or types of content as part of the content protection service. A protection policy may be to alias, conceal, or alias and conceal an original content item. A protection policy may also include information such as for how long the protection may be in effect, or how much time before the protection may take effect. A protection policy may further include information such as whether the protection is related to a predefined event, a predefined sender, a predefined recipient, etc.

If no protection policy exists, the electronic messaging server 504 may send at step 706 the electronic message content as is to a next hop. If a protection policy exists, at step 703, the electronic messaging server 504 may scan the electronic message content for a content item. If the protection policy is to alias the content item, the electronic messaging server 504 may search a content relationship database (e.g., in a content relationship database storage unit 506) and decide if the content item scanned at step 703 is already aliased. Each time a content item is aliased, a new entry of a pair of original content item and aliased content item may be stored in the content relationship database storage unit 506. To decide if the content item scanned at step 703 is already aliased, the electronic messaging server 504 may inquire the content protection database storage unit 506 to see if there is a matching alias. If it is, then the electronic messaging server 504 may send at step 706 the electronic message content as is to a next hop. If the protection policy is to conceal the content item, and if there is no content item scanned at step 703, then the electronic messaging server 504 may assume the content item is concealed and may send at step 706 the electronic message content as is to a next hop.

If the content scanned at step 703 is not already aliased or concealed according to the protection policy, the electronic messaging server 504 may engage at step 704 a protection service (e.g., in the content protection policy verification unit 505). The electronic messaging server 504 may analyze whether the protection policy comprises aliasing only, concealing only, or both aliasing and concealing a content item. Based on the protection policy, then at step 705, the electronic messaging server 504 may modify the electronic message content, and at step 706, the electronic messaging server 504 may send the modified electronic message content to a next hop.

FIG. 7B depicts a flowchart for engaging a content protection service in a content protection policy verification unit 505 on an electronic messaging server (e.g., server 504) in accordance with one or more illustrative aspects described herein. At step 704.1, the electronic messaging server 504 may check a protection policy. The electronic messaging server 504 first checks the protection policy in the content protection policy verification unit 505 whether aliasing is needed. If aliasing is needed, it may check whether the content is already aliased. This may be achieved by checking the content against a content relationship database stored in a content relationship database storage unit 506. Each time a content item is aliased, a new entry of a pair of original content item and aliased content item may be stored in the content relationship database storage unit 506. To decide if the content item is already aliased, the electronic messaging server 504 may inquire the database storage unit 506 to see if there is a matching alias. If the content is not already aliased, at step 704.2, the electronic messaging server 504 may generate aliased content by generating a random series of alphanumeric characters according to the same format of the series of alphanumeric characters of the original content item. For instance, an aliased social security number may have 9 digits, same as the original social security number. If aliasing is not needed, or if the content is already aliased, or after the electronic messaging server 504 generates aliased content, it may further check if the content needs to be concealed. If the content needs to be concealed, at step 704.3, the electronic messaging server 504 may generate a concealment, e.g., a URL link, a clickable button, an electronic form, etc. Then at step 704.4, the electronic messaging server 504 may return a modified electronic message content to be relayed onto a next hop or to an electronic messaging receiving device 507. If the content does not need to be concealed, the electronic messaging server 504 may directly go to step 704.4 and return a modified electronic message content. Depending on the protection policy, a modified electronic message content may be aliased content with the original content omitted, a concealment with the original number omitted, or a concealment with both the aliased and original contents omitted. In some embodiments aliasing may not be permitted, e.g., because it might result in another valid content item belonging to someone else. For example, a user's social security number should not be replaced with someone else's social security number, lest that cause further confusion resulting from using an improper social security number. Thus, whether aliasing is permitted might depend on whether the aliased value can be successfully mapped or forwarded to the original value (e.g., as with phone numbers and email addresses).

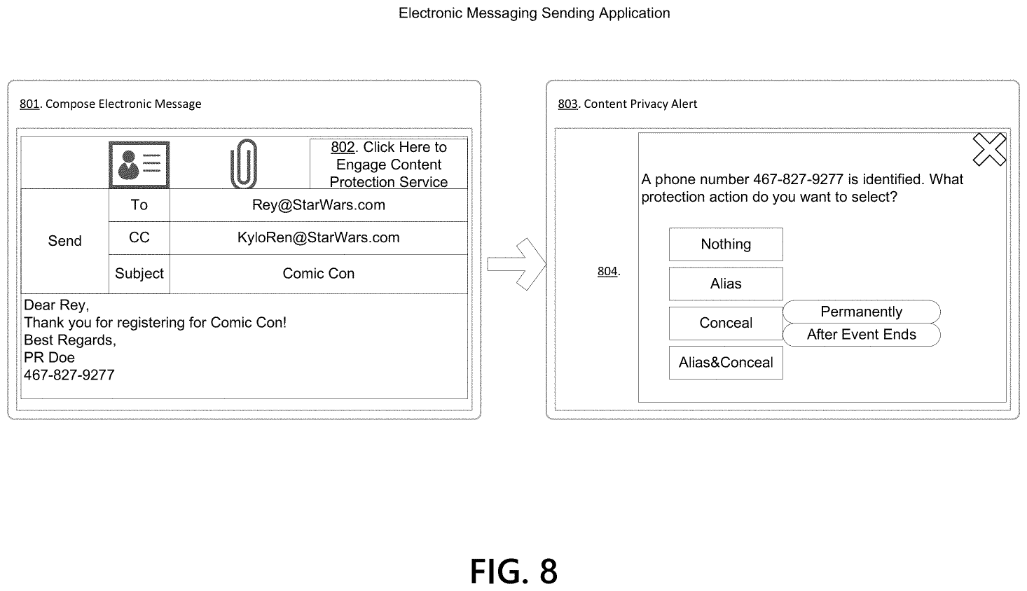

FIG. 8 depicts an illustrative implementation of a content protection action plug-in in an electronic messaging sending application (e.g., application 501) in accordance with one or more aspects described herein. A content protection service activation control may be embedded in a user interface 801 of an electronic messaging sending application 501. For instance, in an example electronic message composing user interface 801, the content protection action may be depicted as a plug-in 802. It may be a button that may be embedded in a part of the user interface 801. The user may manually select a content item and click the “Content Protection Service” plug-in 802, which may provide the user a list of protection actions 804 to select from. The list of protection actions 804 may be presented in a content privacy alert 803 pop-up window. Alternatively, the electronic messaging sending application 501 may automatically identify a content item by comparing a format of a series of alphanumeric characters to a known format. For instance, a birthday may comprise three groups of digits separated by a slash punctuation between each group. The electronic messaging sending application 501 may then automatically suggest a list of protection actions 804 from which the user could select one when “Send” is hit. The user may select one or more protection actions described herein, or nothing. In some embodiments, the electronic message content might not be sent without selection of at least one protection action. In some embodiments, the electronic messaging system may suggest one recommended protection action based on the type of the content item or based on machine learning associated with the content protection history of the user account. The electronic messaging system may also rank a list of protection actions 804 based on the type of the content item or based on machine learning associated with the content protection history of the user account, so that the action to be most likely selected may be at the top of the list.

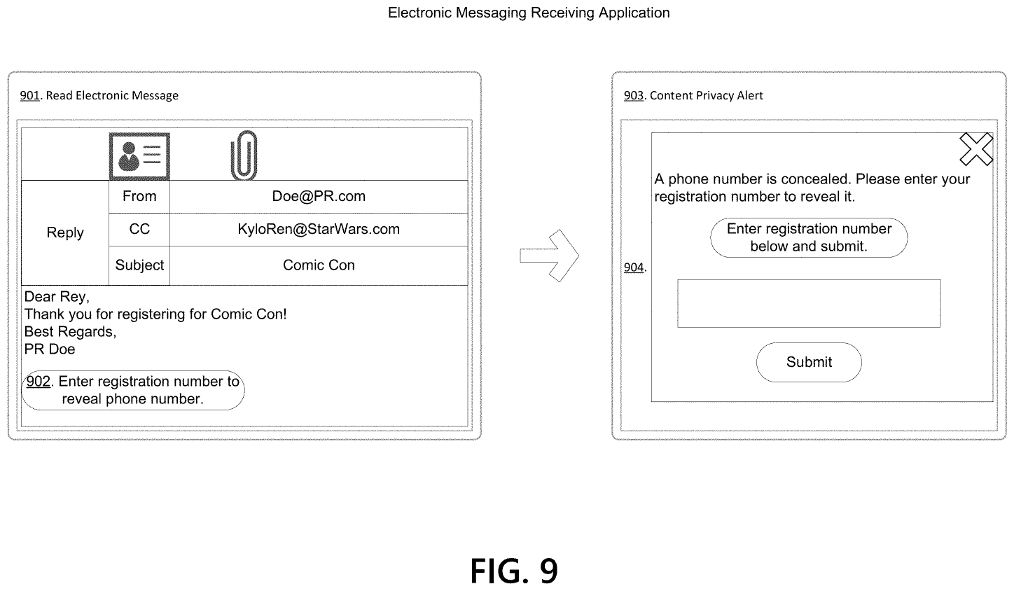

FIG. 9 depicts an illustrative implementation of a protected content in an electronic messaging receiving application (e.g., application 508) in accordance with one or more aspects described herein. The modified electronic message content may be displayed on a user interface 901 and may contain aliased content, and/or concealed content. There may be an overlay (e.g., button 902) of an aliased content item or a concealment on top of the original content item. To reveal the modified electronic message content, it may be required to fill out some information, such as a registration number or an account login. The electronic messaging receiving application 508 may generate a content privacy alert 903 pop-up window for the user to enter required information. For instance, 904 provides a field where the user may enter a registration number and submit so as to reveal the concealed phone number. There may be other requirements needed to reveal a concealed content item. It may be required to click a button. It may be required to follow a URL link. It may be be required to enter a payment method. Alternatively, it may be required to watch a predefined period of time of a video of an advertisement.

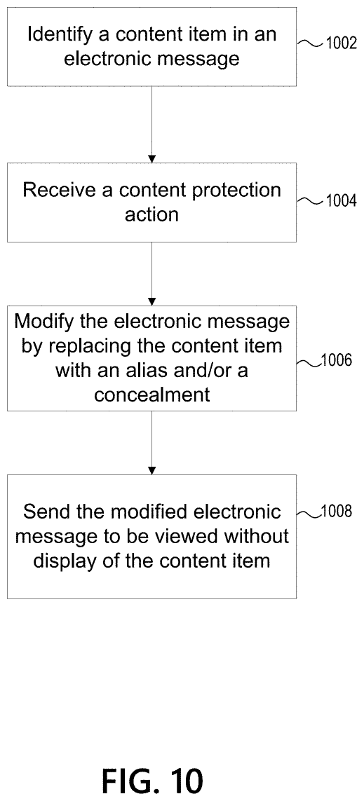

FIG. 10 depicts an example method for protecting a content item in an electronic messaging system in accordance with one or more illustrative aspects described herein. Step 1002 identifies, by a computing device, a content item of an electronic message. Step 1004 receives, by the computing device, a content protection action for the content item of the electronic message. Step 1006 modifies, by the computing device, the electronic message in response to receipt of a content protection action, the modification of the electronic message including comprising at least one of replacement of the content item with at least one of an alias and a concealment of the content item within the electronic message. Step 1008 sends, by the computing device, the modified electronic message to another computing device of an electronic messaging system, the modified message configured to be displayed by the another computing device so that the modified message is viewable by a user without display of the content item.

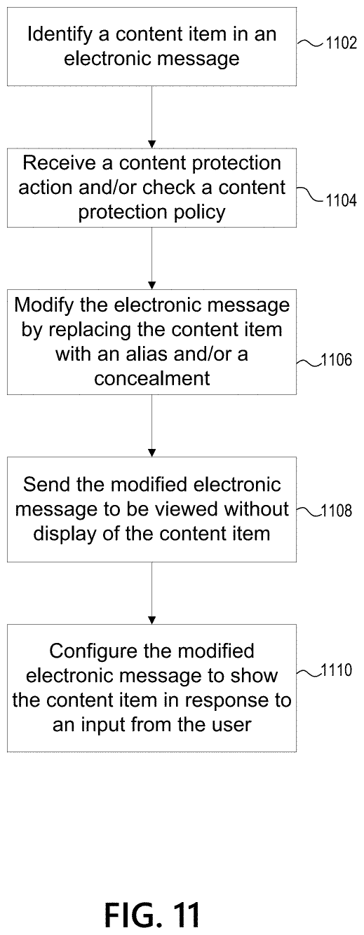

FIG. 11 depicts another example method for protecting a content item in an electronic messaging system in accordance with one or more illustrative aspects described herein. Step 1102 identifies, by a computing device, a content item of an electronic message. Step 1104 receives, by the computing device, a content protection action for the content item of the electronic message. Additionally, or alternatively, step 1104 identifies a content protection policy by way of a lookup table or list. Step 1106 modifies, by the computing device, the electronic message in response to receipt of a content protection action and/or identification of a content protection policy, the modification of the electronic message including comprising at least one of replacement of the content item with at least one of an alias and a concealment of the content item within the electronic message. Step 1108 sends, by the computing device, the modified electronic message to another computing device of an electronic messaging system, the modified message configured to be displayed by the another computing device so that the modified message is viewable by a user without display of the content item. Step 1110 configures the modified electronic message to show the content item in response to an input from the user of the another computing device.

Thus, as described above, in some embodiments a content protection service is engaged to alias, conceal, or alias and conceal an original content item permanently. This may be achieved by an electronic messaging client receiving a protection action when an electronic message content is composed. Or this may be achieved by an electronic messaging server checking a protection policy after receiving an electronic message content. The aliasing, concealing, or aliasing and concealing may be to all recipients. It may also be to a predefined group of recipients.

In some embodiments, a content protection service is engaged to generate aliased content that may be valid only for a predefined period of time. If the content is a phone number, before the predefined period of time expires, calling the aliased phone number may be directed to the original phone number. After the predefined period of time expires, calling the aliased phone number may not be directed to the original phone number.

In some embodiments, a content protection service is engaged to generate aliased content that may be valid only during a predefined event, such as a training course, a conference, a club membership, etc.

In some embodiments, a content protection service is engaged to generate aliased content only for a predefined group of recipients. For example, if a recipient is within the same organization, institute, etc. as a sender, no aliased content is needed. If a recipient is not within the same organization, institute, etc. as a sender, aliased content may be generated.

In some embodiments, a content protection service to conceal is engaged after a predefined period of time, so that the content is available only for a limited period of time. For example, a recipient may be registered for a training course, a conference, a club membership, etc. A sender may want the recipient to have access to their content in an electronic message content only before and during the training course or the conference, or when the recipient remains a club member. After the training course or the conference ends, or after the recipient's membership expires, or after a period of follow-up time after those events, the sender may want to restrict the access to the content in the electronic message content. This content may be the original content. Or it may be aliased content when a content protection service to alias is engaged at the time of electronic message content composing or sending.

In some embodiments, a content protection service to conceal is engaged until certain information is collected. For example, a sender may send an electronic message content to a recipient but not know some of the recipient's information, such as name, address, job title, age, educational level, etc. This information may be pertinent to having access to the content. The content may stay concealed until such information is entered by the recipient. Entering such information may be in the style of an electronic form, or it may be in the style of a URL link, and the URL link may take the recipient to a web page to fill out such information.

In some embodiments, a content protection service to conceal is engaged until a fee is collected. For example, a sender may send an electronic message content to a recipient but the content may stay concealed until the recipient pays a fee to reveal it. Paying such a fee may be in the style of a payment method information form, or it may be in the style of a URL link, and the URL link may take the recipient to a secure payment web page to pay such a fee.

In some embodiments, a content protection service to conceal is engaged until an advertisement action is completed. For example, a sender may send an electronic message content to a recipient but the content may stay concealed until the recipient completes an advertisement action. An advertisement action may be considered completed when a URL link to an advertisement is clicked on by the recipient, or a video of an advertisement is watched by the recipient for a predefined period of time, etc.

In some embodiments, a content protection service to conceal is engaged until a trigger is started, such as a button being clicked. For example, a sender may send an electronic message content to a recipient but not know whether the recipient is truly interested in the electronic message content. The content may stay concealed until a trigger is started, such as a button being clicked by the recipient. The sender may get a track on the trigger and may know whether the recipient starts the trigger to reveal the content, showing that they are interested in knowing the content.

In some embodiments, a content protection service to conceal is engaged for the recipients not within a predefined group of recipients. For example, a sender may send an electronic message content to a recipient within a predefined group of recipients, but the recipient may forward the electronic message content to other recipients. An electronic messaging server may engage the content protection service to check the protection policy and match the forwarded recipients to the predefined group of recipients. If they are within the predefined group of recipients, no concealing is needed. If they are not within the predefined group of recipients, the content protection service may be engaged to conceal the content.

In some embodiments, a content protection service to conceal is engaged for senders within a predefined group of senders. For example, a predefined group of senders such as a group of high-level managers, executives, etc. may have contents too important to be disclosed to any recipients. When a sender from a predefined group sends an electronic message content, an electronic messaging server may engage the content protection service even when the sender neglects to define a protection action. A protection policy may be in place for senders from the predefined group. An electronic messaging server may engage the content protection service to conceal the content.

In some embodiments, a content protection policy may exist for an electronic messaging system (such as text, email, messaging applications, etc.) associated with a sender account. After the sender sends an electronic message, the electronic messaging server may automatically scan the electronic message content for possible sensitive content items. It may compare the scanned content items against a known sensitive content item format. For instance, a social security number may comprise 9 digits. If the electronic messaging server determines that there may be sensitive content items such as a social security number, it may alias and/or conceal the sensitive content items before sending to a recipient. This may prevent the sender from sending sensitive content items over electronic messaging systems inadvertently.

Embodiments described above are not mutually exclusive unless explicitly contradictory to one another. Although the subject matter has been described in language specific to structural features and/or methodological acts, it is to be understood that the subject matter defined in the appended claims is not necessarily limited to the specific features or acts described above. Rather, the specific features and acts described above are described as example implementations of the following claims.

In the above description of the various embodiments, reference is made to the accompanying drawings identified above and which form a part hereof, and in which is shown by way of illustration various embodiments in which aspects described herein may be practiced. It is to be understood that other embodiments may be utilized and structural and functional modifications may be made without departing from the scope described herein. Various aspects are capable of other embodiments and of being practiced or being carried out in various different ways.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “mounted,” “connected,” “coupled,” “positioned,” “engaged” and similar terms, is meant to include both direct and indirect mounting, connecting, coupling, positioning and engaging.

What is claimed is:

1. A method comprising:
identifying, by a computing device, a content item of an electronic message;
modifying, by the computing device, the electronic message in response to receipt of a content protection action, the modification of the electronic message comprising replacement of the content item with at least one of an alias and a concealment of the content item within the electronic message; and
sending, by the computing device, the modified electronic message to another computing device of an electronic messaging system, the modified message configured to be displayed by the another computing device so that the modified message is viewable by a user without display of the content item.

2. The method of claim 1, further comprising:
receiving, by the computing device, a content protection action for the content item of the electronic message.

3. The method of claim 1, wherein the electronic messaging system comprises an electronic messaging sending device, an electronic messaging server, and an electronic messaging receiving device.

4. The method of claim 1, wherein the alias of the content item is permanent.

5. The method of claim 1, wherein the alias of the content item is valid for a period of time.

6. The method of claim 1, wherein the alias of the content item is valid for a duration of an event.

7. The method of claim 1, wherein the alias of the content item is valid for a recipient.

8. The method of claim 1, further comprising:
configuring the modified message to show the content item in response to an input from the user of the another computing device.

9. The method of claim 1, wherein the replacement of the content item with the alias comprises an overlay of an aliased content item on top of the content item so as to block the content item from view during the display of the modified message by the another computing device.

10. The method of claim 1, further comprising:
modifying, by the computing device, the electronic message in response to identification of a content protection policy, the modification of the electronic message comprising replacement of the content item with at least one of an alias and a concealment of the content item within the electronic message, wherein the replacement of the content item with the concealment comprises an overlay of the concealment on top of the content item so as to block the content item from view during the display of the modified message by the another computing device.

11. The method of claim 10, further comprising:
predefining a period of time, wherein the concealment takes effect after the predefined period of time.

12. The method of claim 10, wherein the concealment comprises a URL link, wherein the display of the content item requires providing an input on the URL link.

13. The method of claim 10, wherein the concealment comprises a button, wherein the display of the content item requires clicking the button.

14. The method of claim 10, wherein the concealment comprises an electronic form, wherein the display of the content item requires filling out the electronic form.

15. The method of claim 10, wherein the concealment comprises a fee form, wherein the display of the content item requires paying the fee.

16. The method of claim 10, wherein the concealment comprises an advertisement, wherein the display of the content item requires completion of an advertisement action.

17. The method of claim 10, further comprising:
concealing an aliased content item, wherein the modified message comprises a concealment of the aliased content item and omits the content item and the aliased content item.

18. An apparatus comprising:
one or more processors; and
memory storing instructions that, when executed by the one or more processors, cause the apparatus to:
identify a content item of an electronic message;
modify the electronic message in response to receipt of a content protection action, the modification of the electronic message comprising replacement of the content item with at least one of an alias and a concealment of the content item within the electronic message; and
send the modified electronic message to another computing device of an electronic messaging system, the modified message configured to show the content item in response to an input from a user of the another computing device.

19. A non-transitory computer-readable medium storing instructions that, when executed by one or more processors, cause the processors to:
identify a content item of an electronic message;
modify the electronic message in response to receipt of a content protection action, the modification of the electronic message comprising replacement of the content item with at least one of an alias and a concealment of the content item within the electronic message; and
send the modified electronic message to another computing device of an electronic messaging system, the modified message configured to be displayed by the another computing device so that the modified message is viewable by a user without display of the content item.

20. The non-transitory computer-readable medium of claim 19, wherein the instructions, when executed by the one or more processors further cause the processors to:
modify the electronic message in response to identification of a content protection policy, the modification of the electronic message comprising replacement of the content item with at least one of an alias and a concealment of the content item within the electronic message; and
configure the modified message to show the content item in response to an input from the user of the another computing device.
